(19) United States
(12) Patent Application Publication
(10) Pub. No.: US 2015/0363128 A1
(43) Pub. Date: Dec. 17, 2015

(54) COMPUTER SYSTEM AND MANAGEMENT SYSTEM AND MANAGEMENT METHOD OF STORAGE SYSTEM

(71) Applicant: Hitachi, Ltd., Tokyo (JP)

(72) Inventors: Yusuke FUNAYA, Tokyo (JP); Kazuhide AIKOH, Tokyo (JP); Keisuke HATASAKI, Tokyo (JP); Akihisa NAGAMI, Tokyo (JP)

(73) Assignee: Hitachi, Ltd., Tokyo (JP)

(21) Appl. No.: 14/761,090

(22) PCT Filed: Mar. 18, 2013
(86) PCT No.: PCT/JP2013/057601

§ 371 Date: Jul. 15, 2015

(51) Int. Cl. G06F 3/06

(52) U.S. Cl. CPC G06F 3/0619; G06F 3/0689; G06F 3/0665

(57) ABSTRACT

A management system manages at least a storage system. The management system decides two or more logical storage devices configuring a logical volume to be provided to an application. The management system decides two or more MPs that undertake processes on the two or more logical storage devices, respectively. The management system allocates the decided two or more MPs to the decided two or more logical storage devices such that one MP is allocated to one logical storage device.

### TECHNICAL FIELD

The present invention relates to management of a storage system including a plurality of microprocessors.

### BACKGROUND ART

Generally, a storage system creates a logical storage device, and provides the created logical storage device to a host computer. The host computer recognizes the logical storage device as a logical volume. When data is input to or output from the logical volume, an input/output (I/O) request designating the logical storage device corresponding to the logical volume is transmitted from the host computer to the storage system. The storage system receives the I/O request, and performs an I/O operation on the logical storage device designated by the I/O request.

Generally, an I/O operation on the logical storage device is performed by a microprocessor (MP).

In a technique disclosed in PTL 1, a logical volume recognized by an application program (hereinafter, “application”) stored in a host computer is associated with a logical storage device managed by a storage system in a one-to-one manner. Further, in the technique disclosed in PTL 1, an MP that undertakes an I/O operation is configured for each logical storage device in advance. In other words, in the technique disclosed in PTL 1, when the storage system receives an I/O request for a certain logical storage device from the host computer, an MP that takes charge of the logical storage device processes the I/O request.

### CITATION LIST

### Patent Literature

[PTL 1]
U.S. Patent Application Publication No. 2008/0263190

### SUMMARY OF INVENTION

### Technical Problem

In recent years, a storage system has employed a storage device having a high I/O performance, for example, a flash memory device such as a solid state drive (SSD) as a storage device in which data is finally stored. However, even when a logical storage device is created based on a storage device having a high I/O performance, there are cases in which a high I/O performance is not implemented due to a performance of an MP that take charge of the logical storage device.

As a technique for solving this problem, a technique in which a plurality of MPs take charge of a single logical storage device is considered. However, when this technique is employed, it is difficult to keep consistency of an I/O process on a logical storage device, and there may be another problem in that an overhead occurs due to switching of an MP.

### Solution to Problem

A management system decides two or more logical storage devices configuring a logical volume to be provided to an application. The management system decides two or more MPs that undertake processes on the two or more logical storage devices, respectively. The management system allocates the decided two or more MPs to the decided two or more logical storage devices such that one MP is allocated to one logical storage device. For example, the management system may be configured with one or a plurality of computers. Further, the management system may be provided inside or outside the storage system or may be provided inside or outside the host computer.

### Advantageous Effects of Invention

It is possible to provide a logical volume expected to implement a required performance to an application program of a host computer even when a storage system is configured such that a single MP takes charge of a single logical storage device.

### BRIEF DESCRIPTION OF DRAWINGS

FIG. 1 is a configuration diagram of a computer system according to a first embodiment.

FIG. 2 is a configuration diagram illustrating a management computer 300 according to the first embodiment.

FIG. 3 is a configuration diagram of a CM-PK 240 according to the first embodiment.

FIG. 4 is a configuration diagram of a host computer 100 according to the first embodiment.

FIG. 5 illustrates an exemplary configuration of a static information table 3104 according to the first embodiment.

FIG. 6 illustrates an exemplary configuration of a parity group information table 3105 according to the first embodiment.

FIG. 7 illustrates an exemplary configuration of a maximum performance usage table 3106 according to the first embodiment.

FIG. 8 illustrates an exemplary configuration of an input information table 3107 according to the first embodiment.

FIG. 9 illustrates an exemplary configuration of an ownership table 2413 according to the first embodiment.

FIG. 10 illustrates an example of an MP configuration information table 2415 according to the first embodiment.

FIG. 11 illustrates an example of a PG configuration information table 2416 according to the first embodiment.

FIG. 12 illustrates an example of an LVM-LDEV number correspondence table 1107 according to the first embodiment.

FIG. 13 is a flowchart illustrating an example of a volume creation process according to the first embodiment.

FIG. 14 is a flowchart illustrating an example of an LDEV number decision process according to the first embodiment.

FIG. 15 is a flowchart illustrating an example of an MP allocation process according to the first embodiment.

FIG. 16 is a configuration diagram of a management computer 300 according to a second embodiment.

FIG. 17 illustrates an exemplary configuration of a dynamic information table 3108 according to the second embodiment.

FIG. 18 is a flowchart illustrating an example of an MP allocation process according to the second embodiment.

FIG. 19 is a configuration diagram of a management computer 300 according to a third embodiment.

FIG. 20 is a flowchart illustrating an example of a process including a logical volume reconfiguration process according to the third embodiment.

FIG. 21 illustrates an example of an excessive MP performance table 3111 according to a fourth embodiment.

FIG. 22 is a flowchart illustrating an example of a volume creation suspension process according to the fourth embodiment.

### DESCRIPTION OF EMBODIMENTS

Hereinafter, exemplary embodiments will be described with reference to the accompanying drawings.

Further, the following embodiments are not intended to limit inventions set forth in the appended claims, and all combinations of features described in embodiments are not necessarily required for the solution of the invention.

Further, in the following description, various kinds of information will be described through an expression of “aaa table,” but various kinds of information may be expressed by a data structure other than a table. In order to express that it does not depend on a data structure, “aaa table” may be called “aaa information.”

Further, in the following description, there are cases in which a process will be described using a “program” as a subject, but since a program is executed by a processor (for example, a central processing unit (CPU) or a microprocessor (MP)) and performs a given process while appropriately using a storage resource (for example, memory) and/or a communication interface device (for example, port), a program may be recognized as a subject of a process. A process described using a program as a subject may be a process performed by a processor or by a computer (for example, a management computer, a host computer, or a storage apparatus) including the processor. Further, a processor may include a hardware circuit that performs all or a part of a process performed by the processor. A program may be installed in each controller from a program source. For example, a program source may be a program distribution server or a storage medium.

### First Embodiment

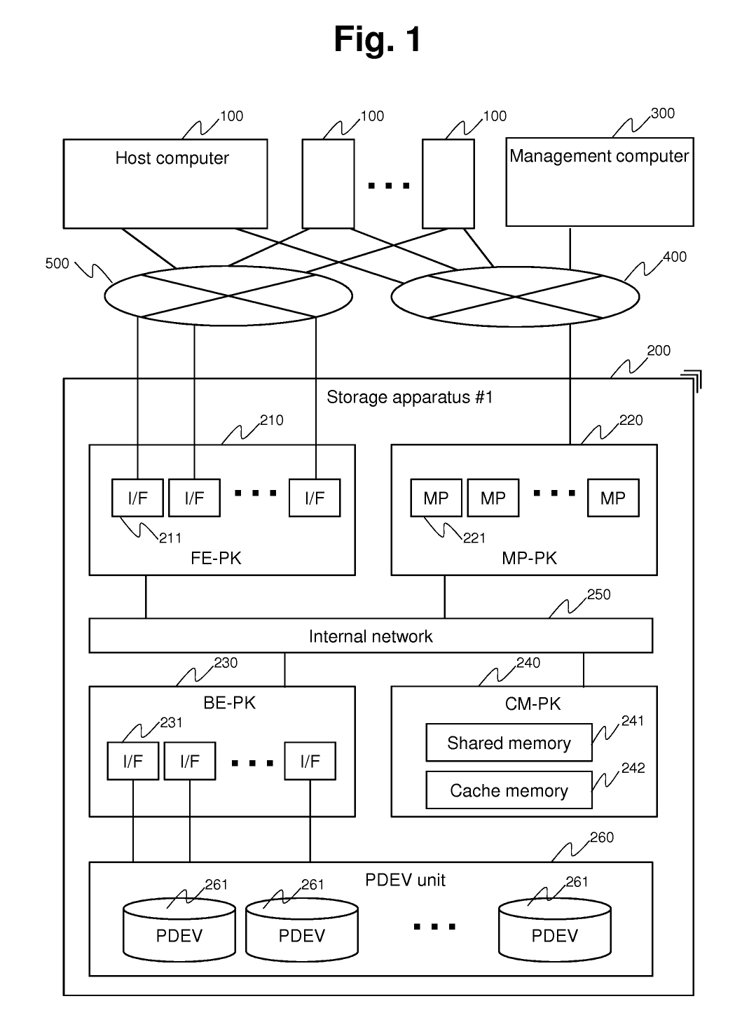

FIG. 1 is a configuration diagram of a computer system according to a first embodiment.

A computer system includes a storage system, a host computer 100 of the storage system, and a management computer 300. The number of the host computers 100 may be one or more. The storage system includes one or more storage apparatuses 200. The storage system may be a single virtual storage system into which one or more storage apparatuses 200 are integrated.

The storage apparatus 200 provides a logical device (LDEV) which is a logical storage device to the host computer 100. The host computer 100 transmits an input/output (I/O) request (a write request or a read request) designating an LDEV to the storage apparatus 200, and writes or reads data in or from the LDEV. The management computer 300 manages the host computer 100 and the storage apparatus 200.

The host computer 100 is coupled to the storage apparatus 200 via a storage network 500. For example, the storage network 500 is a storage area network (SAN). Various kinds of communication media (for example, various kinds of communication networks or buses (for example, a peripheral components interconnect express (PCIe)) may be employed instead of the storage network 500.

Further, the host computer 100 and the storage apparatus 200 are coupled to the management computer 300 via a management network 400. For example, the management network 400 may be a local area network (LAN) or may be a dedicated line. Various kinds of communication media (for example, various kinds of communication networks or buses) may be employed instead of the management network 400. Further, the management network 400 and the storage network 500 may be the same communication medium.

The storage system includes a first communication interface device with the host computer 100, a second communication interface device with the management computer 300, a plurality of microprocessors (MPs), and a plurality of LDEVs. An MP performs a data I/O operation on an LDEV specified by an I/O request from the host computer 100. An LDEV may be a real LDEV or a virtual LDEV. A real LDEV is an LDEV based on one or more physical devices (PDEVs), and a virtual LDEV may be an LDEV according to thin provisioning or may be an LDEV created as external storage resources which are virtualized according to a storage virtualization technique. In the present embodiment, all LDEVs are assumed to be real LDEVs.

For example, the storage system is configured with one or more storage apparatuses 200 as described above.

The storage apparatus 200 includes a frontend package (FE-PK) 210, a microprocessor package (MP-PK) 220, a backend package (BE-PK) 230, a cache memory package (CM-PK) 240, an internal network 250, and a PDEV unit 260.

The FE-PK 210 is an example of the first communication interface device, and includes a plurality of interfaces (I/F) 211. The I/F 211 performs communication with the host computer 100.

The MP-PK 220 includes a plurality of MPs 221. Each MP 221 is configured to perform communication with all of the FE-PK 210, the BE-PK 230, and the CM-PK 240 via the internal network 250, and performs a data I/O process on an LDEV.

The BE-PK 230 includes a plurality of I/Fs 231 coupled to the PDEV unit 260. The I/F 231 performs communication with the PDEV unit 260.

The CM-PK 240 includes a shared memory 241 and a cache memory 242. The shared memory 241 is a memory that stores management information (for example, tables which will be described later) referred to by the plurality of MPs 221. The cache memory 242 is a memory that temporarily stores data read from the PDEV unit 260 and data to be written in the PDEV unit 260. The shared memory 241 and the cache memory 242 may be memories independent of each other or may be respectively storage areas provided on the same memory.

The internal network 250 is a network (for example, a switch device such as a crossbar switch) that couples the FE-PK 210, the MP-PK 220, the BE-PK 230, and the CM-PK 240 with one another.

The PDEV unit 260 includes a plurality of PDEVs 261. The PDEV 261 is a physical storage device such as a hard disk drive (HDD) or a solid state drive (SSD).

In the present embodiment, an LDEV is a real LDEV based on one or more PDEVs 261 as described above, and more specifically, is an LDEV based on a parity group. A parity group is configured with a plurality of PDEVs 261 and stores data at a predetermined RAID level. An LDEV is formed based on a storage space of a parity group and is provided to the host computer 100.

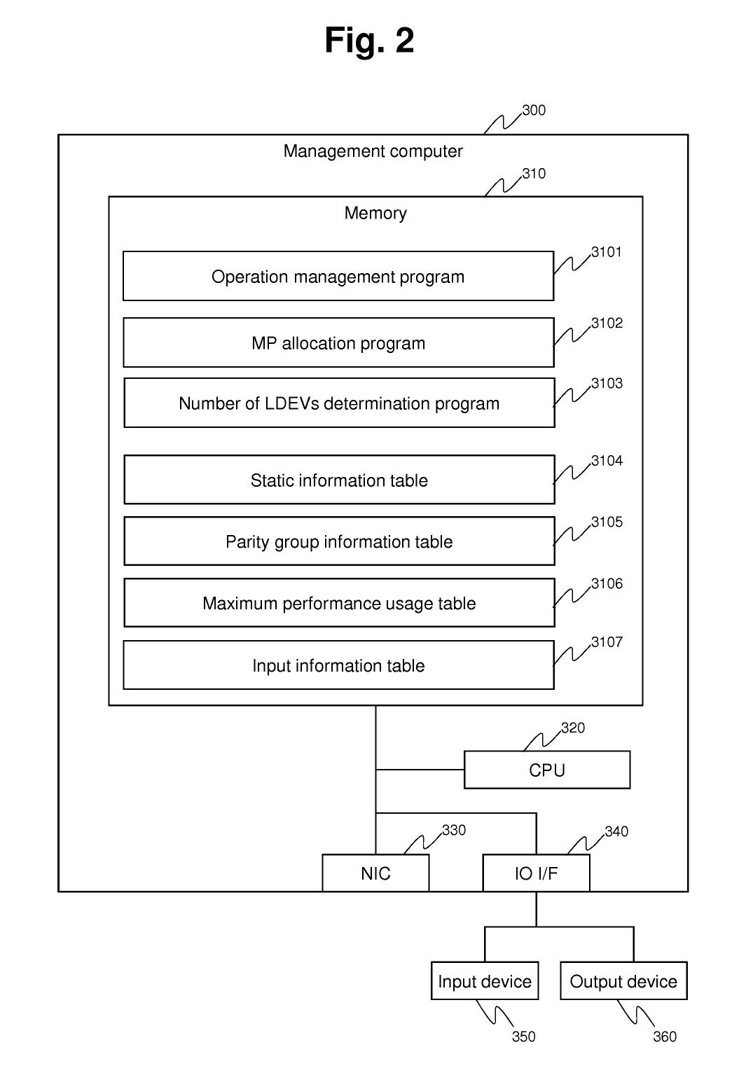

FIG. 2 is a configuration diagram illustrating the management computer 300 according to the first embodiment.

The management computer 300 is an example of a computer including an interface device, a storage device, and a processor coupled thereto. A memory 310 is an example of the storage device, a central processing unit (CPU) 320 is an example of the processor, and a network interface card (NIC) 330 and an I/O I/F 340 are examples of the interface device.

For example, an input device 350 such as a keyboard and an output device 360 such as a display may be coupled to the I/O I/F 340. The input device 350 and the output device 360 may be configured integrally with each other or may be remote I/O consoles coupled to the management computer 300.

The memory 310 of the management computer 300 stores computer programs such as an operation management program 3101, an LDEV number determination program 3103, and an MP allocation program 3102. The memory 310 further stores information such as a static information table 3104, a parity group information table 3105, a maximum performance usage table 3106, and an input information table 3107. Various kinds of functions are implemented as the CPU 320 executes various kinds of programs (3101 to 3103) stored in the memory 310.

The operation management program 3101 is a program that performs an operation management of the computer system. The LDEV number determination program 3103 is a program that decides an MP that is to process an I/O request for an I/O operation on a logical volume of a required performance designated through the input device 350. In the present embodiment, a decision of an MP means a decision of the number of MPs. LDEVs, which are equal in number to the decided number of MPs, are LDEVs configuring a logical volume of a required performance designated through the input device 350. The MP allocation program 3102 is a program that allocates an MP to an LDEV.

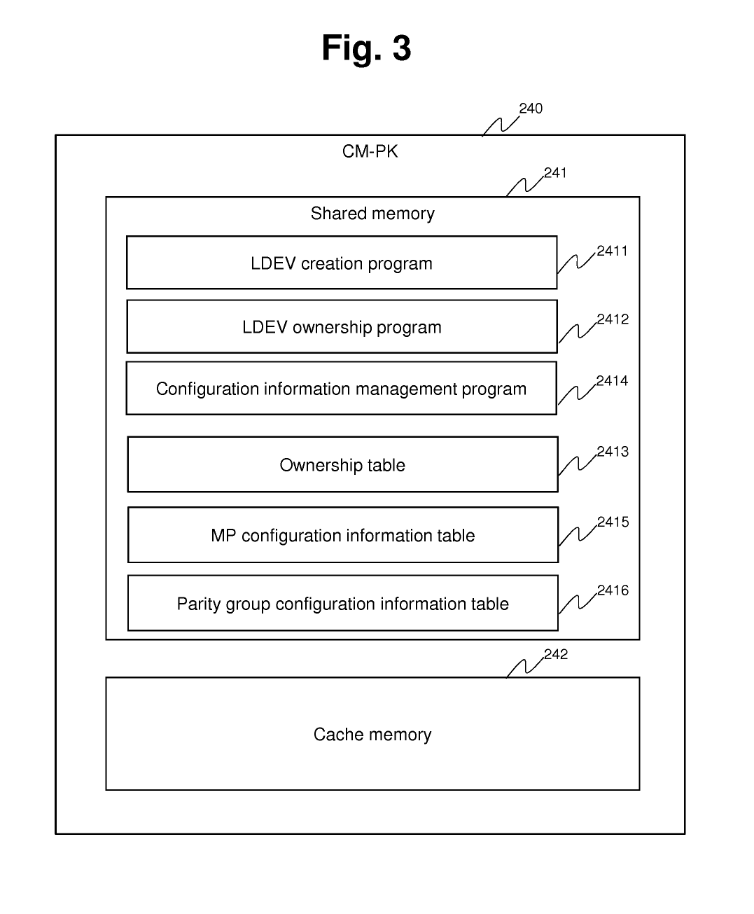

FIG. 3 is a configuration diagram of the CM-PK 240 according to the first embodiment.

The CM-PK 240 includes the shared memory 241 and the cache memory 242 as described above.

The shared memory 241 stores computer programs such as an LDEV creation program 2411, an LDEV ownership program 2412, and a configuration management program 2414. The shared memory 241 further stores information such as an ownership table 2413, an MP configuration information table 2415, and a parity group configuration information table 2416. The cache memory 242 temporarily stores data read from the PDEV unit 260 and data to be written in the PDEV unit 260 as described above.

The LDEV creation program 2411 is a program that creates an LDEV from a parity group. The LDEV ownership allocation program (hereinafter, ownership program) 2412 is a program that allocates an MP to the created LDEV. The configuration information management program (hereinafter, configuration management program) 2414 is a program that creates the parity group configuration information table 2416. In the following description, an abbreviation “PG” is used, and PG stands for a parity group.

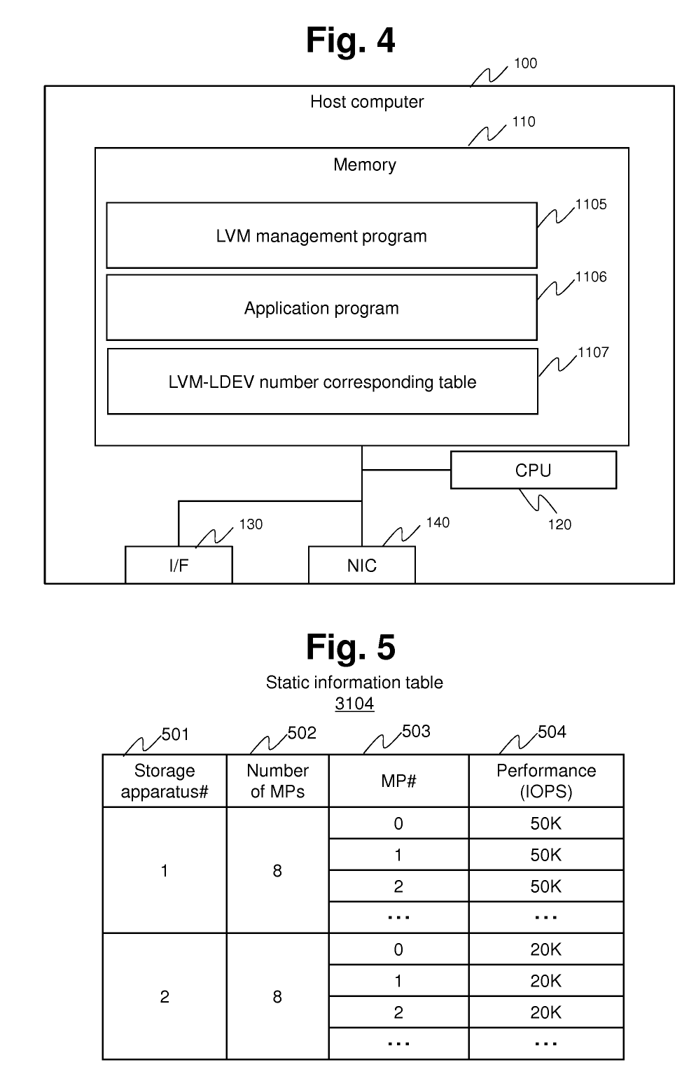

FIG. 4 is a configuration diagram of the host computer 100 according to the first embodiment.

The host computer 100 is an example of a computer including an interface device, a storage device, and a processor coupled thereto. A memory 110 is an example of the storage device, a CPU 120 is an example of the processor, and an I/F 130 and an NIC 140 are examples of the interface device.

The I/F 130 performs communication with the storage apparatus 200 via the storage network 500. The NIC 140 performs communication with the management computer 300 via the management network 400.

The memory 110 stores computer programs such as a logical volume manager (LVM) management program 1105 and an application program 1106. The memory 110 further stores information such as an LVM-LDEV number correspondence table 1107. Although not illustrated, the memory 110 stores an operating system (OS), and the application program 1106 is executed on the OS. The CPU 120 executes various kinds of programs stored in the memory 110. The LVM management program 1105 provides a plurality of LDEVs provided from the storage system (one or more storage apparatuses 200) to the application program 1106 as a single logical volume. The application program 1106 performs a data I/O (write/read) operation on the logical volume. In this case, an I/O request designating an LDEV of an I/O destination (an LDEV corresponding to an I/O destination in a logical volume) is transmitted from the host computer 100 to the storage apparatus 200 that provides the LDEV of the I/O destination.

FIG. 5 illustrates an exemplary configuration of the static information table 3104 according to the first embodiment.

The static information table 3104 is a table in which static information (hereinafter, static information) related to a performance of the storage apparatus 200 is stored. The static information is fixed information that does not dynamically change according to a load of the storage apparatus 200, and in the example in FIG. 5, at least the number of MPs 502 and a performance 504 are static information. Each information item stored in the static information table 3104 is information acquired from the MP configuration information table 2415. Specifically, the operation management program 3101 of the management computer 300 transmits a query to the configuration management program 2414 of the storage apparatus 200, and the configuration management program 2414 acquires information from the MP configuration information table 2415 in response to the query, and transmits the acquired information to the operation management program 3101 of the management computer 300. The transmitted information is information stored in the static information table 3104.

The static information table 3104 stores a storage apparatus# 501, the number of MPs 502, an MP# 503, and a performance 504 in association with one another for each storage apparatus 200.

The storage apparatus# 501 is information (for example, a number) identifying the storage apparatus 200. The number of MPs 502 is information representing the number of MPs equipped in the storage apparatus 200. The MP# 503 is information identifying an MP. The performance 504 is information representing a performance of an MP (for example, an input output per second (IOPS) which is an I/O performance of an MP). In the present embodiment, an I/O performance of an MP is the number (for example, a maximum number) of I/O requests which can be processed per unit time, and may be a response time (a time length until a response is transmitted after an I/O request is received) instead of or in addition to the number of I/O requests.

In the following description of a table or the like, an expression of “performance” is used, but “performance” is assumed to represent an IOPS. Thus, a “**performance” represents an IOPS of “**.” Further, a “performance” is not limited to an IOPS as described above.

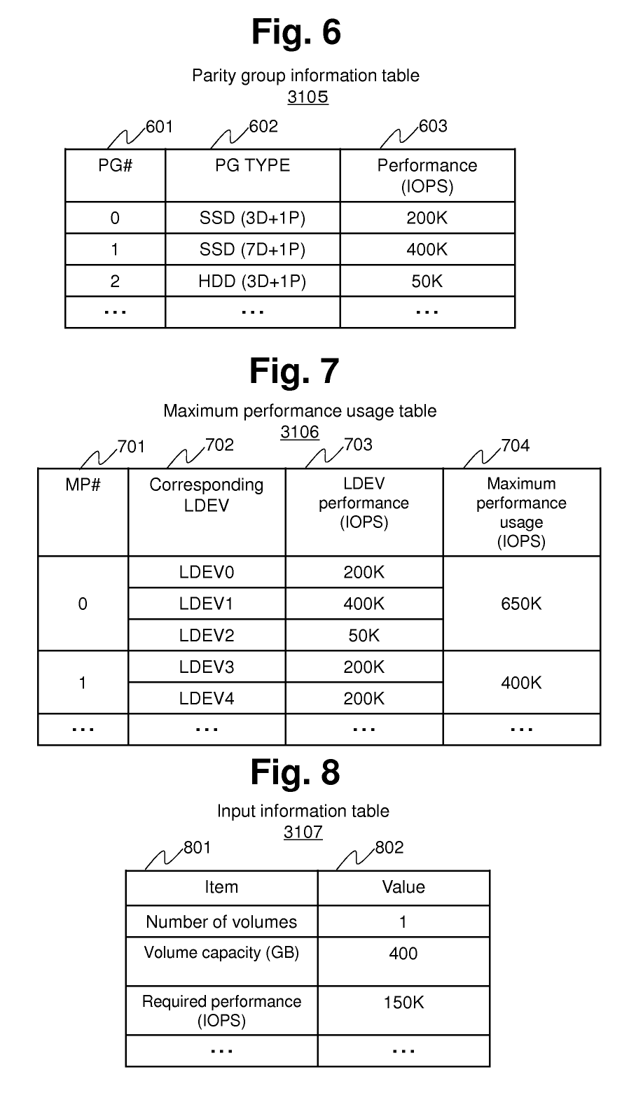

FIG. 6 illustrates an exemplary configuration of the PG information table 3105 according to the first embodiment.

The PG information table 3105 is a table in which information related to a performance (typically, an I/O performance) of a PG is stored. The PG information table 3105 stores a PG# 601, a PG type 602, and a performance 603 in association with one another for each PG.

The PG# 601 is information (for example, a number) identifying a PG.

The PG type 602 is information representing a type of PDEV 261 configuring a PG and a RAID configuration (for example, a RAID level of a PG and the number of PDEVs 261 configuring a PG) of a PG.

A PG# and a PG type are stored in the PG configuration information table 2416 by the configuration management program 2414 of the CM-PK 240 when a PG is newly created. Then, the operation management program 3101 transmits a query to the configuration management program 2414, acquires the PG# and the PG type from the PG configuration information table 2416, and stores the acquired PG# and the PG type in the PG information table 3105 as the PG# 601 and the PG type 602.

The performance 603 is information representing a performance of a PG. The performance is a value which is decided according to the PG type 602. For example, the performance 603 may be a result (value) calculated by the operation management program 3101 based on the PG type 602 acquired from the configuration management program 2414.

In the drawing, a plurality of PGs are configured in the single PDEV unit 260 (that is, the single PDEV unit 260 includes a plurality of types of PDEVs 261), but a single PG may be configured by the single PDEV unit 260.

FIG. 7 illustrates an exemplary configuration of the maximum performance usage table 3106 according to the first embodiment.

The maximum performance usage table 3106 is a table in which a maximum performance usage of each MP 221 is stored. A maximum performance usage will be described later.

The maximum performance usage table 3106 stores an MP# 701, a corresponding LDEV 702, an LDEV performance 703, and a maximum performance usage 704 in association with one another for each MP.

The MP# 701 is information (for example, a number) identifying the MP 221 equipped in the MP-PK 220. The operation management program 3101 acquires an MP# 1002 from the MP configuration information table 2415 through the configuration management program 2414, and stores the acquired MP# 1002 in the maximum performance usage table 3106 as the MP# 701.

Here, in the present embodiment, there is a restriction that the number of MPs 221 capable of taking charge of a data I/O process on a single LDEV is one. In the present embodiment, a right of the MP 221 capable of taking charge of an I/O process of an LDEV is referred to as “ownership.”

The corresponding LDEV 702 is information identifying an LDEV whose ownership is owned by the MP 221. Information representing a correspondence relation between an LDEV and the MP 221 having an ownership of the corresponding LDEV is stored in the ownership table 2413. The operation management program 3101 acquires information of an LDEV taken care of by each MP 221 from the ownership table 2413 through the configuration management program 2414, and stores the acquired information as the corresponding LDEV 702.

The LDEV performance 703 is information representing a performance (typically, an I/O performance) of an LDEV. The LDEV performance 703 is substantially equivalent to a PG performance of a PG to which a corresponding LDEV belongs, and is acquired from the PG information table 3105 by the operation management program 3101.

The maximum performance usage 704 is information representing a total value of the LDEV performance 703 of LDEVs whose ownership is owned by the MP 221. The operation management program 3101 adds the LDEV performance 703 of the LDEV whose ownership is owned by the MP 221 for each MP 221, and stores the added value in the maximum performance usage table 3106 as the maximum performance usage 704.

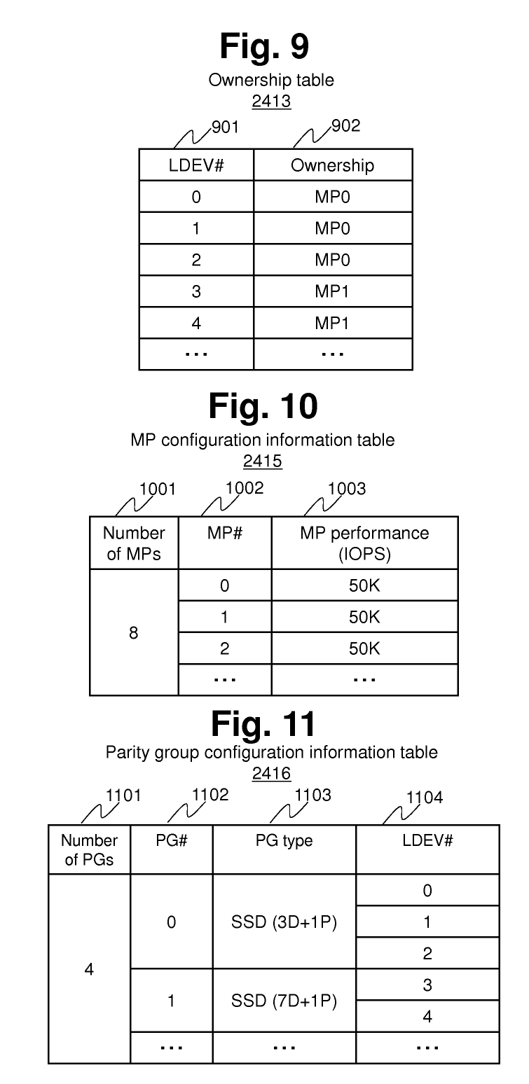

FIG. 8 illustrates an exemplary configuration of the input information table 3107 according to the first embodiment.

The input information table 3107 is a table in which a condition related to logical volume creation is stored.

An item 801 includes input items such as “the number of volumes” which is the number of logical volumes which the user desires to create, “required performance” which is a performance required for a logical volume, and “volume capacity” which is the capacity required for a logical volume. Each input item in the item 801 is associated with a value 802. Each value 802 is a value input through the input device 350. At least one value may be a fixed default value. Further, the operation management program 3101 may transmit information stored in the input information table 3107 to the storage apparatus 200 via the management network 400.

FIG. 9 illustrates an exemplary configuration of the ownership table 2413 according to the first embodiment.

The ownership table 2413 is a table representing a correspondence between an LDEV and the MP 221 having an ownership thereof. The ownership table 2413 stores an LDEV# 901 and an ownership 902 in association with each other for each LDEV.

The LDEV# 901 is information (for example, a number) identifying an LDEV. When an LDEV is created, the configuration management program 2414 may store the LDEV# 901 in the ownership table 2413 as information identifying the LDEV.

The ownership 902 is information identifying the MP 221 that takes charge of an LDEV. When an LDEV is created, the configuration management program 2414 may store the ownership 902 in the ownership table 2413 as information identifying an MP that takes charge of the LDEV.

FIG. 10 illustrates an example of the MP configuration information table 2415 according to the first embodiment.

The MP configuration information table 2415 includes the number of MPs 1001, the MP# 1002, and an MP performance 1003. One table 2415 may be provided for one storage apparatus 200 or one MP-PK 220.

The number of MPs 1001 is information representing the number of MPs 221 equipped in the storage apparatus 200. The MP#1002 is information identifying the MP 221. The MP performance 1003 is information representing a performance of the MP 221.

The number of MPs 1001, the MP# 1002, and the MP performance 1003 are numerical values defined at the stage of design, and do not change unless a configuration of the MP-PK 220 is changed.

FIG. 11 illustrates an example of the PG configuration information table 2416 according to the first embodiment.

The PG configuration information table 2416 includes the number of PGs 1101, a PG# 1102, a PG type 1103, and an LDEV# 1104 for each PDEV unit 260.

The number of PG 1101 is information representing the number of PGs equipped in the PDEV unit 260. The PG# 1102 is information (for example, a number) identifying a PG. The PG type 1103 is information representing an RAID configuration (for example, a type of PDEV 261, an RAID level, and the number of PDEVs 261 configuring a PG) of a PG. The LDEV#1104 is information identifying an LDEV created based on a PG.

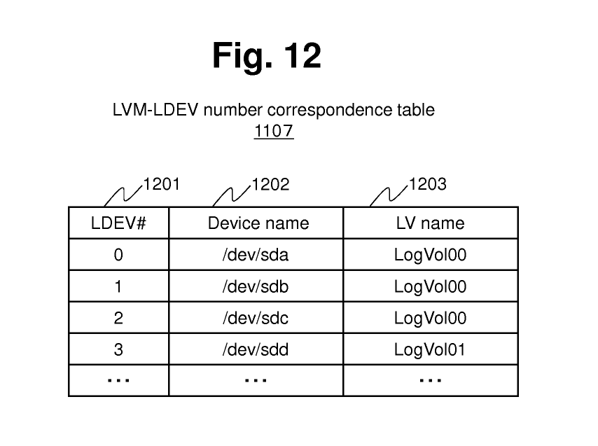

FIG. 12 illustrates an example of the LVM-LDEV number correspondence table 1107 according to the first embodiment.

The LVM-LDEV number correspondence table 1107 stores an LDEV# 1201, a device name 1202, and a logical volume (LV) name 1203 in association with one another for each LDEV.

The LDEV# 1201 is information identifying an LDEV. The device name 1202 is information used for the host computer 100 to identify an LDEV supplied from the storage apparatus 200. The LV name 1203 is information identifying a logical volume configured with a plurality of LDEVs.

The LVM management program 1105 of the host computer 100 stores an LDEV# supplied from the operation management program 3101 as the LDEV# 1201. Then, an OS gives an arbitrary device name 1202 such as “/dev/sda” to the LDEV# 1201. Then, the LVM management program 1105 acquires the device name 1202 of an LDEV stored in the LDEV# 1201 from the OS, configures a logical volume with one or a plurality of LDEVs represented by the device name 1202, and stores information identifying the configured logical volume in the table 1107 as the LV name 1203.

Further, information representing LDEVs that configure a logical volume (for example, a list of LDEV#s of LDEVs configuring a logical volume) may be transmitted from the operation management program 3101 to the LVM management program 1105. The LVM management program 1105 may receive the information and configure a logical volume with a plurality of LDEVs specified from the information. Specifically, the LVM management program 1105 gives the same LV name to the LDEV# 1201 (the device name 1202) configuring the same logical volume, and stores the given LV name in the table 1107 as the LV name 1203.

The application program 1106 performs an I/O operation on a logical volume represented by the LV name 1203, but the host computer 100 can determine an LDEV associated with an I/O destination in a logical volume with reference to the LVM-LDEV number correspondence table 1107.

Next, an example of a process until a logical volume is created after a logical volume creation instruction is received from the user will be described.

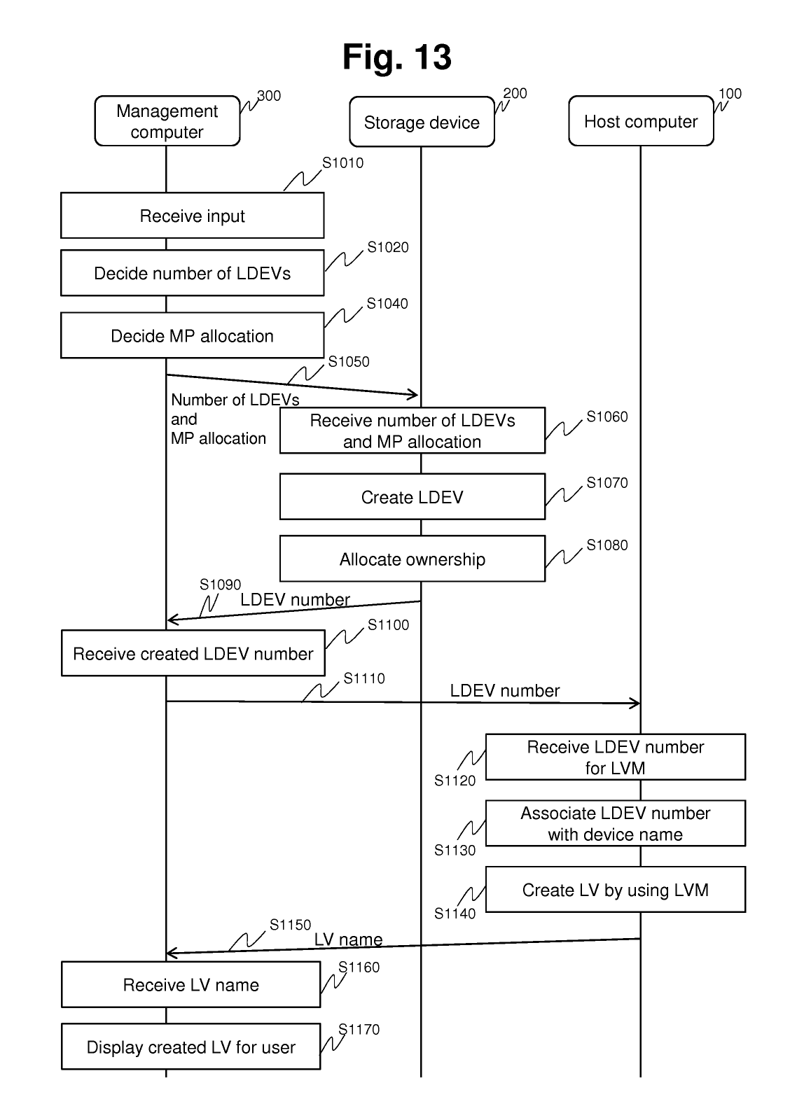

FIG. 13 is a flowchart illustrating an example of a volume creation process according to the first embodiment.

First of all, the user inputs information (for example, the number of logical volumes, a capacity of a logical volume, and a required performance for a logical volume) of a logical volume desired to be created using the input device 350. Then, the operation management program 3101 receives the input information, and stores the information in the input information table 3107 (S1010).

Next, the number of LDEVs determination program 3103 acquires information from the input information table 3107, and decides the number of LDEVs to be created and the like (S1020). Preferably, the decided number of LDEVs is equal to or larger than 1, and for example, the decided number of LDEVs may be a value predetermined based on the acquired information or may be a value calculated based on the acquired information. The details of S1020 will be described later.

Next, the MP allocation program 3102 decides an allocation (ownership) of an MP to each LDEV to be created (S1040). A process of allocating an MP to each LDEV will be described later.

The number of LDEVs determination program 3103 transmits the decided number of LDEVs and information related to MP allocation to the storage apparatus 200 via the management network 400 (S1050).

The storage apparatus 200 receives the number of LDEVs and the information related to MP allocation which are transmitted from the number of LDEVs determination program 3103 (S1060).

Then, in the storage apparatus 200, the LDEV creation program 2411 creates an LDEV based on the information received in S1060 (S1070), and the LDEV ownership program 2412 allocates an MP (configures an ownership) to the created LDEV (S1080).

Here, the storage apparatus 200 (for example, the LDEV creation program 2411 or the LDEV ownership program 2412) transmits a completion report representing that a work has been completed and a plurality of LDEV#s corresponding to a plurality of created LDEVs to the management computer 300 (S1090).

The management computer 300 receives information (the completion report and the plurality of LDEV#s) transmitted from the storage apparatus 200 in S1090 (S1100). The management computer 300 (for example, the operation management program 3101) transmits a logical volume provision instruction to the host computer 100 (S1110). This instruction is associated with the plurality of LDEV#s received in S1100.

The host computer 100 receives the instruction transmitted from the management computer 300 in S1110 (S1120).

In the host computer 100, the LVM management program 1105 stores information (a plurality of LDEV#s) included in the received instruction in the LVM-LDEV number correspondence table 1107, and decides the LV name 1203 of a logical volume to be provided to the application program 1106 (S1130). The LV name 1203 is associated with a plurality of LDEV#s included in the received instruction.

Then, in the host computer 100, the LVM management program 1105 provides a plurality of LDEVs corresponding to the plurality of received LDEV#s to the application program 1106 as a single logical volume based on information of the LVM-LDEV number correspondence table 1107 (S1140).

Here, in the host computer 100, the LVM management program 1105 transmits the report representing that a work has been completed, the LV name 1203 of the created LV, and the like to the management computer 300 (S1150).

The management computer 300 receives information transmitted from the host computer 100 in S1150 (S1160), and causes the received information to be displayed on the output device 360 (S1170).

Through the above process, a logical volume expected to implement a performance required by the user can be configured with a plurality of LDEVs each of which is taken care of by a single MP.

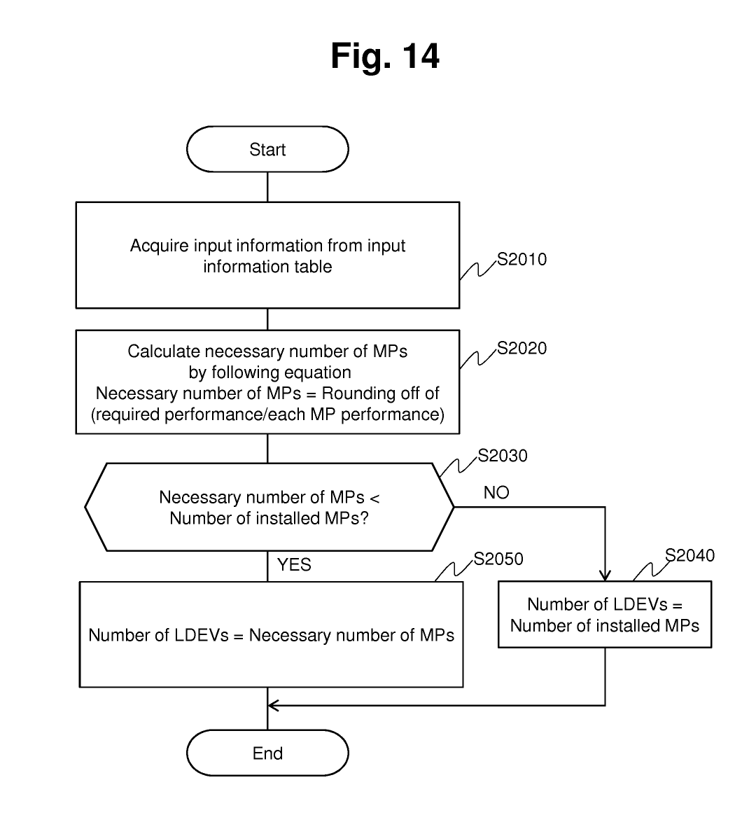

FIG. 14 is a flowchart illustrating an example of the number of LDEVs decision process (S1020 of FIG. 13) according to the first embodiment.

The number of LDEVs determination program 3103 acquires values such as the number of logical volumes, a required performance for a logical volume, and the like from the input information table 3107 (S2010).

Then, the number of LDEVs determination program 3103 calculates the number of MPs (hereinafter, “necessary number of MPs”) necessary to satisfy a performance (hereinafter, “required performance”) which the user requires for a logical volume (S2020).

Specifically, for example, in S2020, the number of LDEVs determination program 3103 may use a number obtained by rounding off a value obtained by dividing the required performance by a performance (the performance 504 of the static information table 3104) of an MP as the necessary number of MPs.

For example, when the number of LDEVs determination program 3103 receives information such as 150K (IOPS) as the user required performance, first, the number of LDEVs determination program 3103 acquires information related to a performance of an MP equipped in the storage apparatus 200 with reference to the performance 504 of the static information table 3104. Here, the number of LDEVs determination program 3103 acquires information representing that a performance of each MP equipped in the MP-PK 220 is 50K (IOPS).

Then, the number of LDEVs determination program 3103 divides the user required performance “150K” by the performance “50K” of the MP. Then, the number of LDEVs determination program 3103 obtains “3” as the necessary number of MPs.

Then, the number of LDEVs determination program 3103 determines whether the necessary number of MPs is smaller than the number of MPs of MPs mounted in the storage apparatus 200 (S2030). Specifically, in S2030, the number of LDEVs determination program 3103 determines whether the number of MPs 502 (that is, a mounted number of MPs which is the number of mounted MPs 221) is smaller than the necessary number of MPs calculated in S2020 with reference to the number of MPs 502 of the static information table 3104.

When it is determined that the necessary number of MPs is smaller than the mounted number of MPs (YES in S2030), the number of LDEVs determination program 3103 uses the necessary number of MPs as the number of LDEVs to be created (S2050).

When it is determined that the necessary number of MPs is equal to or larger than the mounted number of MPs (NO in S2030), the number of LDEVs determination program 3103 uses the mounted number of MPs as the number of LDEVs to be created (S2040).

Through the above process, the number of MPs and the number of LDEVs which satisfy the required performance are decided. In the present embodiment, in the single storage apparatus 200, a plurality of respective MPs has the same performance, and FIG. 14 illustrates an example in which the number of MPs necessary from the single storage apparatus 200 is decided. When a performance of an MP differs according to the storage apparatus 200, an MP for satisfying the required performance may be selected from another storage apparatus 200 based on the performance of the MP.

As a method of deciding the number of LDEVs, for example, a capacity of an LDEV configuring a logical volume may be set to a predetermined capacity, and the number of LDEVs configuring a logical volume may be decided based on the capacity of a logical volume required from the user and the set predetermined capacity. Specifically, for example, a number obtained by dividing the capacity of a logical volume required from the user by the set predetermined capacity may be used as the number of LDEVs configuring a logical volume. In this case, an MP may be allocated to the created LDEV in a round-robin manner from a plurality of MPs or in order from an MP having a low load.

Further, as another method of deciding the number of LDEVs, for example, the number of LDEVs to be created may be used as the number of MPs to be equipped in the storage apparatus 200. In this case, it is desirable to allocate a single MP to each created LDEV.

The two methods of deciding the number of LDEVs can be employed even when a plurality of respective MPs equipped in the single storage apparatus 200 differ in performance in the static information table of FIG. 5.

Further, in the decision of the number of MPs, an MP which is to be allocated to a logical volume of a creation target may be decided. In this case, an MP which is small in a static load (maximum performance usage) may be preferentially selected.

Further, in the decision of the number of LDEVs, a performance of a PG on which an LDEV is based may be decided. Further, a performance of an LDEV to be decided may be decided based on a performance of a decided MP. For example, when an MP having a low performance is decided, an LDEV having a low performance may be decided as an LDEV taken care of by the MP, and when an MP having a high performance is decided, an LDEV having a high performance may be decided as an LDEV taken care of by the MP. From this point of view, a performance of an LDEV to be created and the number of LDEVs to be created may be decided, and decided information (information representing a performance of an LDEV to be created and the number of LDEVs to be created) may be included in information related to the number of LDEVs. The information related to the number of LDEVs may be transmitted from the management computer 300 to the storage apparatus 200, and the storage apparatus 200 may create an LDEV based on the information.

Further, the respective LDEVs have the same capacity, and a capacity of a logical volume may be a multiple of that of an LDEV. The user may input a capacity of a logical volume as a condition, and the number of LDEVs may be decided based on the capacity. A capacity of an LDEV may differ according to an LDEV. The number of LDEVs may be decided based on a volume capacity designated to a logical volume.

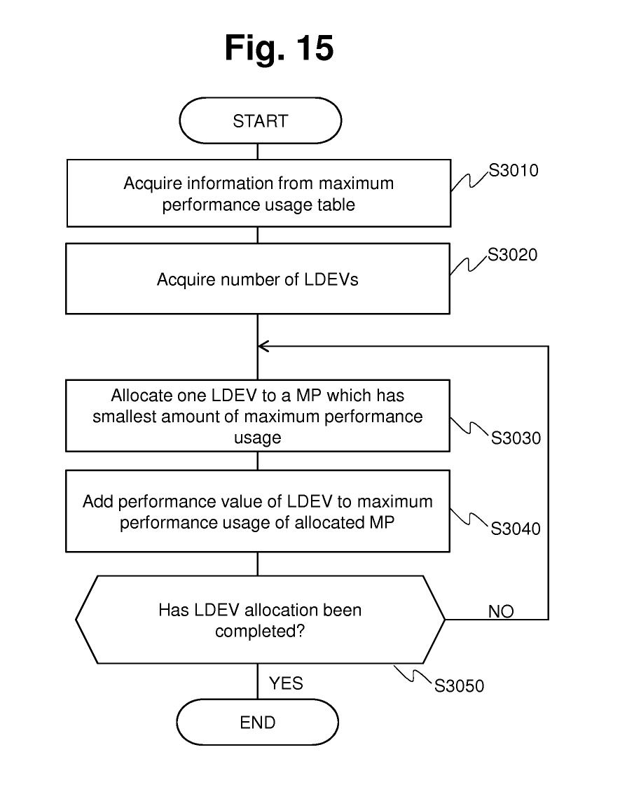

FIG. 15 is a flowchart illustrating an example of the MP allocation process (S1040 of FIG. 13) according to the first embodiment.

The MP allocation program 3102 acquires the maximum performance usage 704 of each MP from the maximum performance usage table 3106 (S3010).

Then, the MP allocation program 3102 receives information related to “the number of LDEVs to be created” from the number of LDEVs determination program 3103 (S3020). The number of LDEVs to be created is the number of LDEVs decided by the flow of FIG. 14. Further, this information may include information representing a performance of an LDEV to be created and the number of LDEVs to be created.

Next, the MP allocation program 3102 searches for the MP#701 which is smallest in the maximum performance usage 704 based on the maximum performance usage 704 acquired in S3010, and allocates an LDEV to the searched MP# 701 (S3030). Here, the MP allocation program 3102 may create an LDEV to be allocated from a PG having a highest performance based on the PG information table 3105 or from a PG selected in advance by the user.

Then, the MP allocation program 3102 adds a value of a performance of an LDEV allocated in S3030 to a value of the maximum performance usage 704 of the MP 221 to which an LDEV is allocated (S3040).

Next, the MP allocation program 3102 determines whether the allocation of an LDEV has been completed (S3050). Here, when it is determined that the allocation of an MP has been completed on all LDEVs of “the number of LDEVs to be created” decided by the flow of FIG. 14 (YES in S3050), the MP allocation program 3102 ends the process. However, when it is determined that the allocation of an MP has not been completed on all LDEVs (NO in S3050), the MP allocation program 3102 performs the process of S3030 again.

As described above, in the first embodiment, when it is determined that a required performance is not satisfied by a single MP on a single logical volume creation instruction using static information, a load of an MP can be dispersed by configuring a single logical volume with two or more LDEVs. Further, in the present embodiment, the MP 221 having a small load can be allocated to each decided LDEV. In other words, a logical volume is configured with an LDEV to which the MP 221 having a small load is practically allocated. As a result, an I/O load from the application program 1106 on a logical volume is dispersed among a plurality of MPs (a plurality of MPs corresponding to a plurality of LDEVs configuring a logical volume). Thus, it is possible to prevent a load from being concentrated on a single MP, and a required performance for a logical volume can be expected to be implemented.

### Second Embodiment

Hereinafter, a second embodiment will be described. Here, the description will proceed in connection with a different point from the first embodiment, and a description of the same points as in the first embodiment will be omitted or simplified.

In the second embodiment, as an MP load referred to when an MP is allocated to an LDEV, a dynamic load that changes according to an operation state of an MP is used instead of (or in addition to) a static load such as the maximum performance usage.

Specifically, in the first embodiment, the MP allocation process (S1040) is performed using the maximum performance usage table 3106 which is static information. In the second embodiment, the MP allocation process is performed using the dynamic information table 3108. In the second embodiment, in the process (S1020) of deciding the number of LDEVs, static information is used, which is similar to the first embodiment.

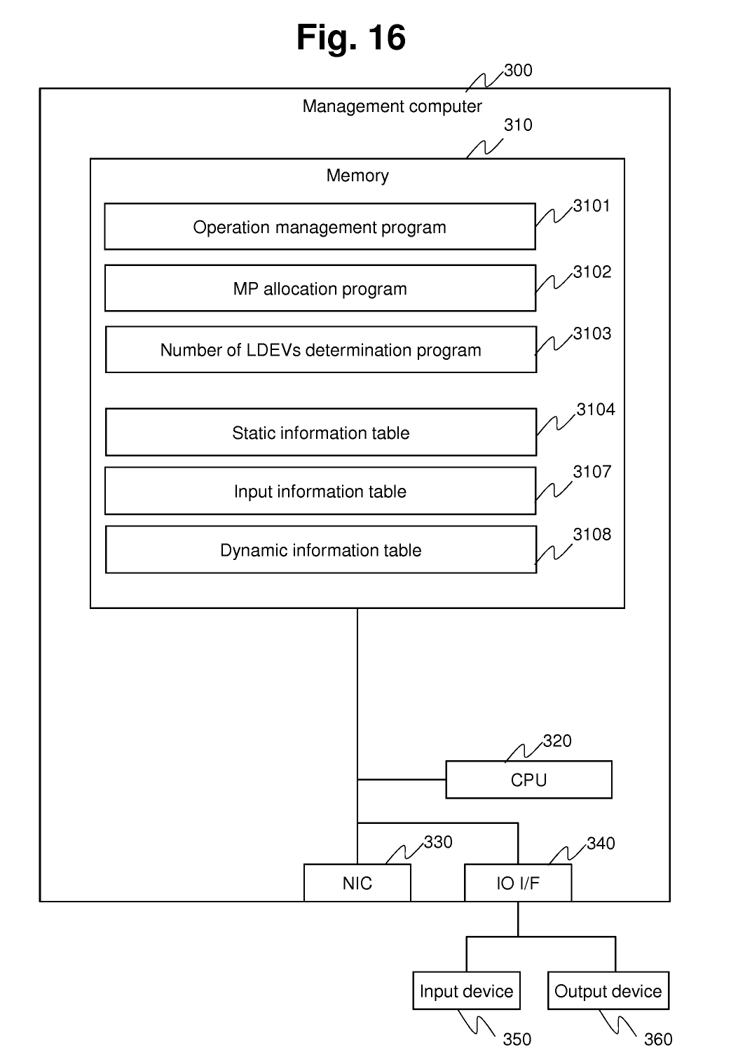

FIG. 16 is a configuration diagram of the management computer 300 according to the second embodiment.

A different point between the management computer 300 of the second embodiment and the management computer 300 of the first embodiment lies in that the dynamic information table 3108 is stored in the memory 310. The remaining configuration is substantially the same as the management computer 300 of the first embodiment, and thus a description thereof will be omitted.

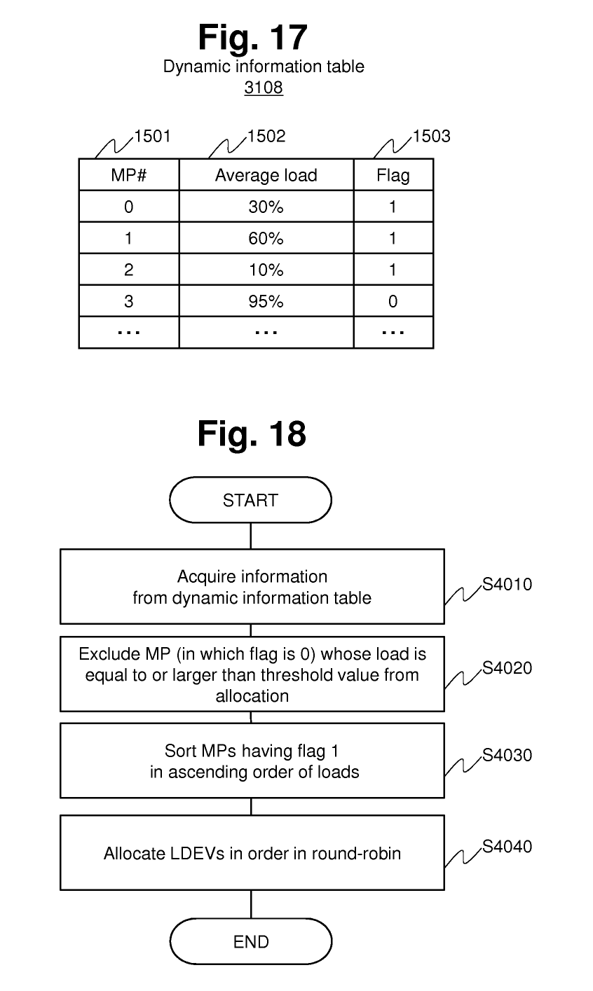

FIG. 17 illustrates an exemplary configuration of the dynamic information table 3108 according to the second embodiment.

The dynamic information table 3108 stores an MP# 1501, an average load 1502, and a flag 1503 in association with one another for each MP 221 equipped in the storage apparatus 200.

The MP# 1501 is information identifying the MP 221 equipped in the MP-PK 220.

The average load 1502 is information representing an average of a load applied to the MP 221. Here, the average load 1502 is an average value of a load (usage rate) of an MP during a certain period of time from a certain time point to a current time point. The average load 1502 may be updated at intervals of a certain period of time. Further, as a dynamic load, a load according to various kinds of statistics, for example, a maximum load or a minimum load may be used instead of the average load 1502.

The average load 1502 is acquired by a function of the storage apparatus 200. Further, a certain period of time may be set based on a time such as one minute or one hour, or may be set based on a process cycle number (for example, a cycle number such as 1 million cycles or 10 million cycles) of the MP 221.

The flag 1503 is information representing whether the average load 1502 of the MP 221 is equal to or larger than a predetermined threshold value (for example, 90%). When the average load 1502 is equal to or larger than the threshold value, the flag 1503 is set to “0,” and when the average load 1502 is smaller than the threshold value, the flag 1503 is set to “1.” Further, for example, a value input by the user or a value decided at the time of shipping may be used as the threshold value.

FIG. 18 is a flowchart illustrating an example of an MP allocation process according to the second embodiment.

The MP allocation program 3102 acquires information related to the average load 1502 from the dynamic information table 3108 (S4010).

Then, the MP allocation program 3102 excludes an MP in which the average load 1502 is equal to or larger than the threshold value (that is, the flag 1503 is set to “0”) (S4020).

Then, the MP allocation program 3102 sorts MPs in which the flag 1503 is “1” in the ascending order of the values represented by the average load 1502 (S4030), and an MP is allocated to an LDEV in order starting from an MP which is low in the average load 1502, for example, in the round-robin manner (S4040).

The process other than the MP allocation process (S1040) is substantially the same as the flowchart illustrated in FIG. 13, and thus a description thereof will be omitted.

The second embodiment has been described above. According to the second embodiment, for example, when a first logical volume to be provided to a first application program of a first host computer 100 is created, a second application program is executed by a second (or first) host computer 100, but while an I/O request is issued to the storage system and one or more MPs are being operated, an MP to be allocated to an LDEV can be decided for a first logical volume based on a dynamic load of an MP.

Through the above process, an MP can be allocated to an LDEV based on a dynamic load of an MP. As a result, similarly to when the maximum performance usage table 3106 (static information) described in the first embodiment is used, a load can be appropriately dispersed among MPs allocated to LDEVs configuring a logical volume.

Further, the MP allocation program 3102 may preferentially allocate to an LDEV an MP which is small in a dynamic load (average load) of an MP among MPs which are the same in a static load (maximum performance usage). Alternatively, the MP allocation program 3102 may preferentially allocate an MP having a smaller static load to an LDEV among MPs which are the same in a dynamic load.

### Third Embodiment

A third embodiment will be described below. Here, the description will proceed in connection with a different point from the first and second embodiments, and a description of the same point as in the first and second embodiments will be omitted or simplified.

It is desirable to be able to change at least one of the number of LDEVs configuring a created logical volume and MP allocation to an LDEV. In the third embodiment, for example, when a load of a logical volume increases to be equal to or larger than a threshold value because a load is not adequately dispersed among a plurality of MPs respectively corresponding to a plurality of LDEVs configuring a logical volume or the like, a logical volume can be reconfigured. Further, in the third embodiment, the MP allocation process may be performed on a process using static information (see FIG. 15) or on a process using dynamic information (see FIG. 18).

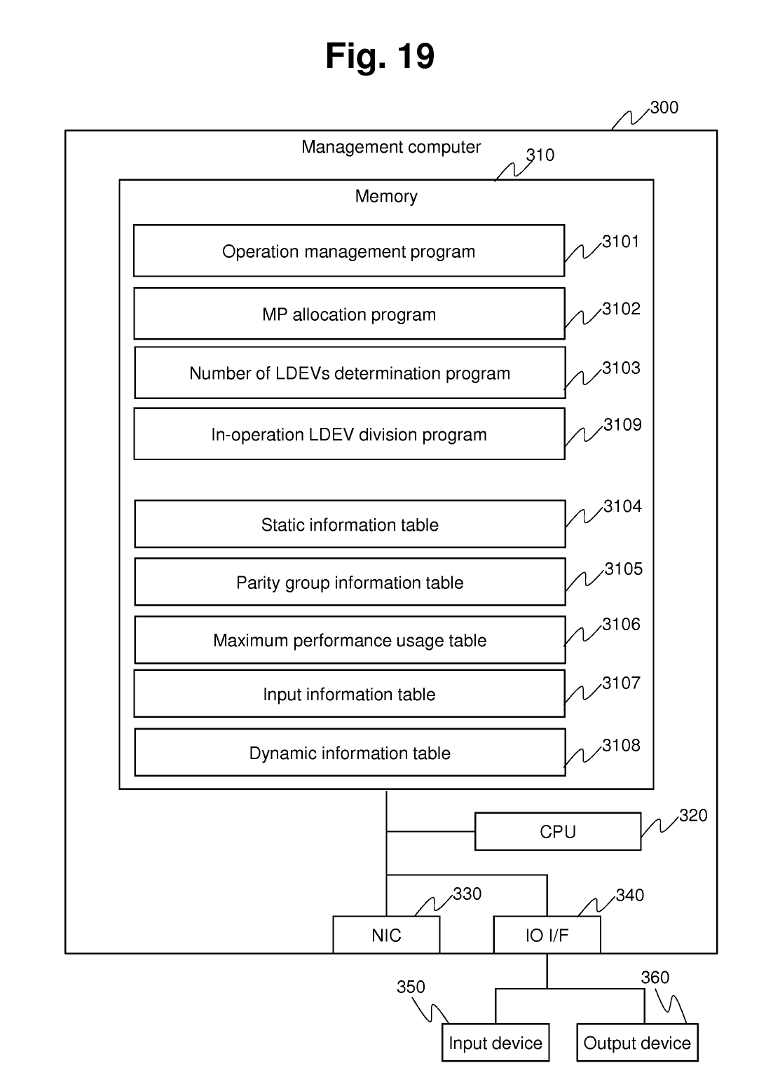

FIG. 19 is a configuration diagram of the management computer 300 according to the third embodiment.

A different point between the management computer 300 of the second embodiment and the management computer 300 of the first embodiment lies in that the dynamic information table 3108 and an in-operation LDEV division program (hereinafter, an in-operation program) 3109 are stored in the memory 310. The remaining configuration is substantially the same as the management computer 300 of the first embodiment, and thus a description thereof will be omitted.

The dynamic information table 3108 is substantially the same in a configuration as the dynamic information table 3108 described in the second embodiment, but the average load 1502 is a load of each MP 221 applied when a certain application is operating. The average load 1502 described in the second embodiment is a load of each MP 221 applied when an application is not operating.

The in-operation number of LDEVs determination program (hereinafter, the in-operation program) 3109 is a program for resetting the set number of LDEVs and an allocation of an MP to each LDEV when an application program is operating.

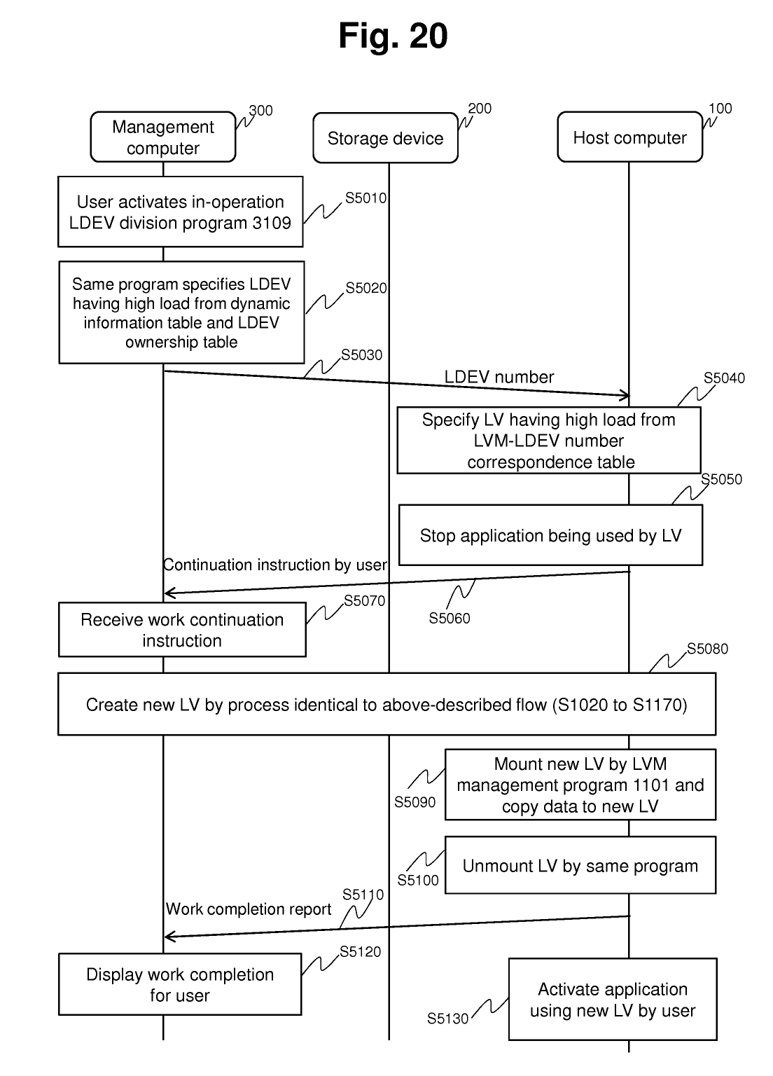

FIG. 20 is a flowchart illustrating an example of a process including a logical volume reconfiguration process according to the third embodiment.

First of all, the user activates the in-operation program 3109 (S5010).

Next, the in-operation program 3109 specifies an MP (the MP# 1501 of an MP in which the flag 1503 is “0”) having a high dynamic load based on the dynamic information table 3108, and further specifies the LDEV# 901 of an LDEV taken care of by an MP represented by the MP# 1501 based on the ownership table 2413 (S5020).

Then, the in-operation program 3109 transmits the specified LDEV# of the LDEV to the host computer 100 (S5030).

The host computer 100 receives the specified LDEV#, and specifies an LV of a logical volume whose load is equal to or larger than a threshold value based on the LVM-LDEV number correspondence table 1107 (S5040). Here, for example, a logical volume “whose load is equal to or larger than a threshold value” may be a logical volume in which a ratio of the number of LDEVs corresponding to the LDEV# received in S5040 to the number of LDEVs configuring a logical volume is equal to or larger than a predetermined ratio.

The host computer 100 stops an application program which is using a logical volume (a logical volume (an old logical volume) whose load is equal to or larger than a threshold value) having a high load (S5050). This stop may be performed in response to the user's instruction. Then, the host computer 100 transmits a work continuation instruction to the management computer 300 in response to the user's instruction (S5060). The work continuation instruction may be transmitted to the management computer 300 after, for example, an OS of the host computer 100 detects a stop of an application program or may be transmitted to the management computer 300 in response to an instruction given from the user using the input device 350.

When the management computer 300 receives the work continuation instruction (S5070), the management computer 300, the storage apparatus 200, and the host computer 100 perform substantially the same processes (logical volume reconfiguration process) as the corresponding processes from S1020 to S1170 of FIG. 13, and create a logical volume (a new logical volume) satisfying the user requiring performance (step S5080).

Next, in the host computer 100, for example, the LVM management program 1105 mounts the new logical volume, copies data from the old logical volume to the new logical volume (S5090), and then unmounts the old logical volume (S5100).

The data copying may be performed by a copy function of the host computer 100 (that is, data may be read from the old logical volume, which may be written to the new logical volume) or may be performed by a copy function of the storage apparatus 200 (that is, data may be copied from a plurality of LDEVs configuring the old logical volume to a plurality of LDEVs configuring the new logical volume without passing through the host computer 100).

The host computer 100 transmits a copy completion report to the management computer 300 (S5110). The management computer 300 receives the copy completion report from the host computer 100, and notifies the user of the fact that a work has been completed through the output device 360 (S5120).

Finally, the user who is using the host computer 100 receives a notification representing that switching of a logical volume has been completed and then activates an application (S5130).

Through the above process, a logical volume satisfying a performance required by the user can be reconfigured. As a result, for example, when a characteristic of an application varies, a logical volume satisfying a required performance can be reconfigured by resetting the number of LDEVs or an MP allocation according to the characteristic of the application.

### Fourth Embodiment

A fourth embodiment will be described below. When a logical volume is created, the user designates a “required performance” which is a performance required for a logical volume. The user expects that a volume satisfying the designated required performance will be created and thus expects that a required performance will be achieved for a volume to be created.

In the present embodiment, at least, when it is clearly difficult to create a logical volume capable of implementing a required performance, the user may be notified of the fact in advance, and creation of a logical volume may be stopped. An example of this method will be described below.

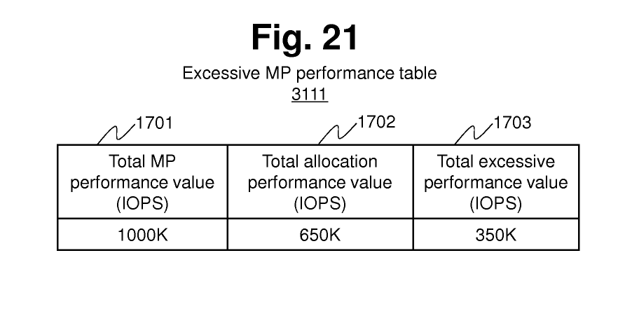

FIG. 21 illustrates an example of an excessive MP performance table 3111 according to the fourth embodiment.

The excessive MP performance table 3111 is stored in the memory 310 of the management computer 300. The excessive MP performance table 3111 includes a total MP performance value 1701, a total allocation performance value 1702, and a total excessive performance value 1703 for each storage apparatus 200.

The total MP performance value 1701 represents a total value of performance values of all the MPs 221 equipped in the storage apparatus 200 (the MP-PK 220). The total allocation performance value 1702 represents a total value of required performances for MPs designated by the user in logical volume creation performed until now. The total excessive performance value 1703 represents a subtracted value (that is, an excessive performance which is currently allocable) obtained by subtracting the total allocation performance value 1702 from the total MP performance value 1701.

The total MP performance value 1701 is calculated such that the operation management program 3101 acquires the performance 504 from the static information table 3104 for each storage apparatus 200 and adds the acquired performance. The total allocation performance value 1702 is calculated such that each time a logical volume is created, the operation management program 3101 adds a value of a required performance designated by the user at that time to the current total allocation performance value 1702. Further, the total excessive performance value 1703 is calculated such that the operation management program 3101 subtracts the total allocation performance value 1702 from the total MP performance value 1701.

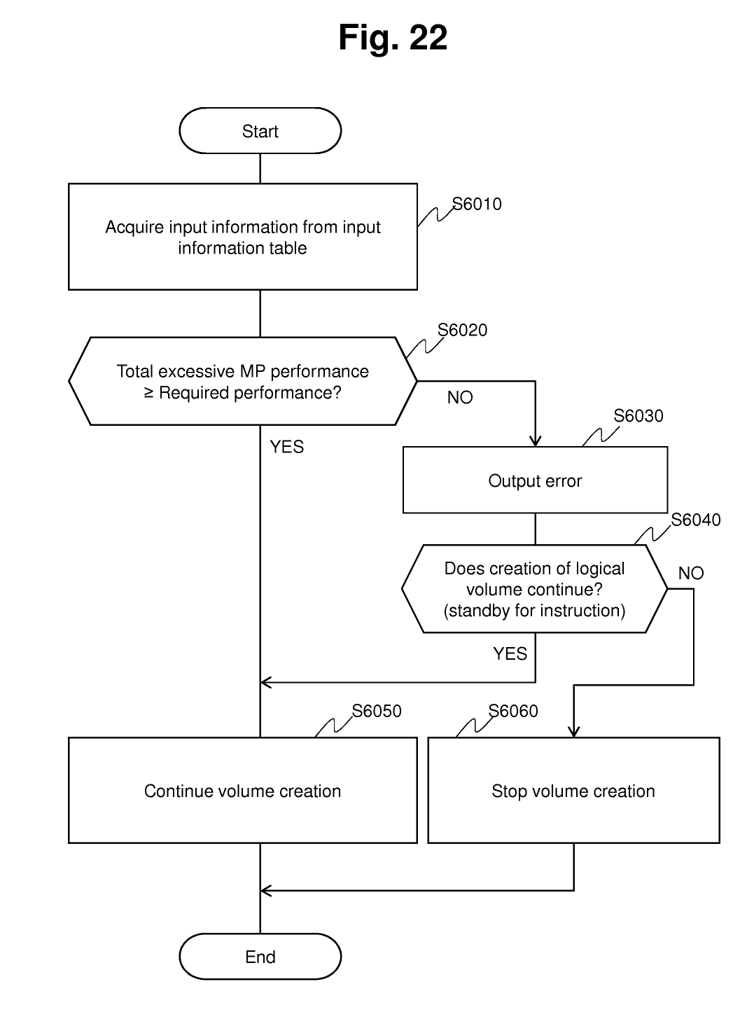

FIG. 22 is a flowchart illustrating an example of a process of deciding volume creation continuation or stop according to the fourth embodiment.

The operation management program 3101 acquires values such as the number of logical volumes and a required performance for a logical volume from the input information table 3107 (S6010).

Next, the operation management program 3101 determines whether the total excessive performance value 1703 is larger than a required performance which the user requires for a logical volume with reference to the excessive MP performance table 3111 (S6020). In other words, in S6020, it is determined whether it is possible to create a logical volume satisfying a required performance required by the user.

When it is determined that the total excessive performance value 1703 is equal to or larger than the required performance (YES in S6020), the operation management program 3101 continues to create a logical volume (S6050).

When it is determined that the total excessive performance value 1703 is smaller than the required performance (NO in S6020), the operation management program 3101 outputs an error to the user through the output device 360 (S6030). The outputting of an error suggests to the user that it is likely to be difficult to achieve a required performance and may be performed using the output device 360 such as a display since it is desirable for the user to determine whether volume creation is to be continued or be stopped nevertheless.

When it is determined that the user is to continue creation of a logical volume (YES in S6040), the operation management program 3101 continues to create a logical volume (S6050). However, when it is determined that the user stops creation of a logical volume (NO in S6040), the operation management program 3101 stops creating a logical volume (S6060).

Through the above process, it is possible to prevent a logical volume determined as being clearly difficult to achieve a required performance from being created without being noticed by the user. Further, the present embodiment may be combined with at least one of the first embodiment and the second embodiment. Specifically, for example, the process of FIG. 22 may be included after S1010 of FIG. 13. As a result, in the first embodiment or the second embodiment, it is possible to prevent a logical volume that does not satisfy a required performance from being created.

The exemplary embodiments have been described above, but the present invention is not limited to the above embodiments.

For example, the LVM management program 1105 that provides a plurality of LDEVs to an application program as a single logical volume may be executed by an apparatus other than the host computer 100, for example, the storage system or may be executed by an apparatus (for example, a switch apparatus) provided between the storage system and the host computer 100.

Further, for example, the management computer 300 may preferentially determine an MP, in which at least one of a static load and a dynamic load is small, to be an MP that is in charge of an LDEV configuring a logical volume of a creation target.

Further, the number of LDEVs to be decided may be larger than the number of MPs to be decided.

### REFERENCE SIGNS LIST

100 Host computer
200 Storage apparatus
300 Management computer
400 Management network
500 Storage network
210 FE-PK
220 MP-PK
230 BE-PK
240 CM-PK
250 Internal network
260 PDEV unit
211 Host I/F
221 MP
231 Storage I/F
241 Shared memory
242 Cache memory
261 PDEV

1. A computer system, comprising:
a storage system that is configured to be coupled to a host computer that is configured to execute an application; and
a management system that is configured to manage at least the storage system of the host computer and the storage system, wherein
the storage system includes at least one storage apparatus that provides a plurality of microprocessors (MPs) and a plurality of logical storage devices,
one MP is determined to be an MP that is in charge of each logical storage device among the plurality of MPs, and input/output (I/O) on the one logical storage device is performed by the MP that is in charge of the logical storage device, and
the management system is configured to
(A) decide two or more logical storage devices configuring a logical volume to be provided to the application,
(B) decide two or more MPs that undertake processes on the two or more logical storage devices, respectively, and
(C) allocate the decided two or more MPs to the decided two or more logical storage devices such that one MP is allocated to one logical storage device.

2. The computer system according to claim 1, wherein in the process of (A), the management system is configured to decide the two or more logical storage devices based on performance management information which is information representing a performance of each of the plurality of MPs and a required performance which is a performance required for a logical volume to be provided to the application so that a relation between performances of two or more MPs to be decided and the required performance satisfies a predetermined condition.

3. The computer system according to claim 2, wherein the management system is configured to manage a total excessive performance value which is a total value of performances of MPs which are not allocated to the logical storage device, compare the required performance with the total excessive performance value, and output information representing that the required performance required for a logical volume is higher than the total excessive performance value when the required performance is higher than the total excessive performance value.

4. The computer system according to claim 1, wherein the management system is configured to decide the two or more logical storage devices based on a predetermined capacity and a capacity of the logical volume in the process of (A).

5. The computer system according to claim 1, wherein in the process of (B), the management system is configured to preferentially determine an MP, which is small in a static load which is a value based on a performance of one or more logical storage devices taken care by an MP, to be an MP that undertakes a process of the decided logical storage device.

6. The computer system according to claim 5, wherein in the process of (B), the management system is configured to preferentially determine an MP, which is small in a dynamic load which is a value that changes according to an operation state of an MP among MPs having the same static load, to be an MP that undertakes a process of the decided logical storage device.

7. The computer system according to claim 1, wherein in the process of (B), the management system is configured to preferentially determine an MP, which is small in a dynamic load which is a value that changes according to an operation state of an MP, to be an MP that undertakes a process of the decided logical storage device.

8. The computer system according to claim 7, wherein in the process of (B), the management system is configured to preferentially determine an MP, which is small in a static load which is a value which is based on a performance of one or more logical storage devices taken care of by an MP among MPs having the same dynamic load, to be an MP that undertakes a process of the decided logical storage device.

9. The computer system according to claim 2, wherein the predetermined condition is a condition in which a total value of performances of the decided two or more MPs is equal to or larger than the required performance.

10. The computer system according to claim 1, wherein
the management system is configured to transmit allocation information related to the decided two or more logical storage devices and the determined two or more MPs to the storage system, and the storage system is configured to create two or more logical storage devices based on the allocation information, allocate the determined two or more MPs to the decided two or more logical storage devices such that one MP is allocated to one logical storage device as an MP in charge, and transmit device identification information of each of the created two or more logical storage devices to the management system,
the management system is configured to transmit device identification information of each of the created two or more logical storage devices to the host computer, and
the host computer is configured to create the logical volume to be provided to the application program in association with device identification information of each of the created two or more logical storage devices.

11. The computer system according to claim 1, wherein the management system is configured to perform the processes of (A) to (C) so that a second logical volume to be provided to the application program is constructed instead of a first logical volume provided to the application program.

12. The computer system according to claim 11, wherein the first logical volume is a logical volume having a high load.

13. The computer system according to claim 11, wherein the host computer is configured to mount the second logical volume, and to copy data from the first logical volume to the second logical volume, and moreover to unmount the first logical volume.

14. A management system, comprising:
an interface device that is configured to perform communication with a storage system that is configured to be coupled to a host computer that is configured to execute an application, include a plurality of microprocessors (MPs), create a logical storage device, determine one MP from the plurality of MPs to be an MP that is in charge of each logical storage device, and implement input/output (I/O) on the one logical storage device through an MP that is in charge of the logical storage device; and
a processor that is configured to be coupled to the interface device, wherein
the processor is configured to
(A) decide two or more logical storage devices configuring a logical volume to be provided to the application,
(B) decide two or more MPs that undertake processes on the two or more logical storage devices, respectively, and
(C) allocate the decided two or more MPs to the decided two or more logical storage devices such that one MP is allocated to one logical storage device.

15. A management method of managing a storage system that is configured to be coupled to a host computer that is configured to execute an application, include a plurality of microprocessors (MPs), create a logical storage device, determine one MP from the plurality of MPs to be an MP that is in charge of each logical storage device, and implement input/output (I/O) on the one logical storage device through an MP that is in charge of the logical storage device,
the method comprising:
deciding two or more logical storage devices configuring a logical volume to be provided to the application;
deciding two or more MPs that undertake processes on the two or more logical storage devices, respectively; and
allocating the decided two or more MPs to the decided two or more logical storage devices such that one MP is allocated to one logical storage device.
